(19) United States
(12) Patent Application Publication
(10) Pub. No.: US 2023/0405468 A1
(43) Pub. Date: Dec. 21, 2023

(54) LEVERAGING MACHINE LEARNING MODELS TO IMPLEMENT ACCESSIBILITY FEATURES DURING GAMEPLAY

(71) Applicant: Microsoft Technology Licensing, LLC, Redmond, WA (US)

(72) Inventors: Christopher John BROCKETT, Kirkland, WA (US); Gabriel A. DESGARENNES, Issaquaah, WA (US); Sudha RAO, Bothell, WA (US); Hamid PALANGI, Bellevue, WA (US); Ryan VOLUM, Seattle, WA (US); Yun Hui XU, Phoenix, AZ (US); Sam Michael DEVLIN, Trumpington (GB); Brannon J. ZAHAND, Issaquah, WA (US)

(73) Assignee: Microsoft Technology Licensing, LLC, Redmond, WA (US)

(21) Appl. No.: 18/199,693

(22) Filed: May 19, 2023

Related U.S. Application Data
(60) Provisional application No. 63/345,216, filed on May 24, 2022.

(51) Int. Cl. A63F 13/67; A63F 13/533; G06N 3/006; G06N 20/00

(52) U.S. Cl. CPC A63F 13/67; G06N 20/00; G06N 3/006; A63F 13/533

(57) ABSTRACT

Aspects of the present disclosure provide systems and methods which utilizes machine learning techniques to provide enhanced accessibility features to a game. An accessibility service is provided which is capable of instantiating one or more machine learning models which can process current gameplay states and generate commands to assist users during gameplay. The accessibility commands may be provided to a game and used to supplement or modify user provided inputs in order to compensate for specific user needs. In further aspects, an accessibility user interface is provided which allows a user to dynamically enable or disable accessibility features during gameplay. The user interface is operable to receive accessibility selections and provide the selection data to an accessibility service during gameplay.

### CROSS-REFERENCE TO RELATED APPLICATIONS

This application claims priority to U.S. Provisional Application Ser. No. 63/345,216, filed May 24, 2022, entitled “Creation and Personalization of Virtual Gamers,” the entire disclosure of which is hereby incorporated herein by reference.

### BACKGROUND

The gaming industry makes up a large portion of the technology sector. As the technology looks towards a future that is more and more connected, gaming will be a central component of the connected future. Artificial intelligence has always been a major component of the gaming industry in general, however, as AI developments continue to advance, it becomes more difficult for the gaming industries to incorporate the advances into games. Further, as the gaming market continues to grow, accessibility features become more important in order to accommodate users having different needs. However, specialized expertise is often required to identify and/or accessibility features, which standard game developers may not have.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure provide systems and methods which utilizes machine learning techniques to provide enhanced accessibility features to a game. An accessibility service is provided which is capable of instantiating one or more machine learning models which can process current gameplay states and generate commands to assist users during gameplay. The accessibility commands may be provided to a game and used to supplement or modify user provided inputs in order to compensate for specific user needs. In doing so, a robust system is provided accessibility to features which can be customized to allow users having different gameplay needs (e.g., visually impaired users, one handed users, etc.) to enjoy the benefits of a game, even if the game does not natively support specific accessibility features.

In further aspects, an accessibility user interface is provided which allows a user to dynamically enable or disable accessibility features during gameplay. The user interface is operable to receive accessibility selections and provide the selection data to an accessibility service during gameplay. The selected accessibility features can be used by the service to instantiate one or more machine learning models operable to generate accessibility commands to incorporate the selected accessibility feature into a game during gameplay.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1A illustrates an overview of an example system for generating and using user personalized agents in a gaming system.

FIG. 1B illustrates on overview of an example system for generating and utilizing personalized agent responses in a gaming system.

FIG. 2 illustrates an example of a method for generating personalized agents.

FIG. 3 depicts an exemplary system 300 for providing an accessibility service 302 using one or more machine learning models.

FIG. 4 illustrates an exemplary method for instantiating accessibility machine learning models to assist users during a gameplay session.

FIG. 5A illustrates an exemplary method for generating accessibility commands using one or more machine learning models.

FIG. 5B illustrates an exemplary method 520 for implementing accessibility features during gameplay.

FIG. 6 depicts an exemplary method 600 for modifying accessibility features based upon changes in a user's gameplay.

FIG. 7 is a block diagram illustrating example physical components of a computing device with which aspects of the disclosure may be practiced.

FIG. 8 is another simplified block diagram of a mobile computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

Aspects of the present disclosure provide systems and methods which utilizes machine learning techniques to provide enhanced accessibility features to a game. As described herein, an accessibility service is provided which can utilize one or more machine learning models to generate accessibility commands that can be executed by a game to provide accessibility features to users. The degree of accessibility features can be customized on a user-by-user basis. Further, as machine learning models are leveraged, gameplay control commands can be generated to help a user during gameplay, for example, to assist one handed users, game state commands can be generated to modify game graphics, for example, to help colorblind or visually impaired users, or the like.

As noted, the accessibility features may be generated through the use of machine learning models that are executed during gameplay. This allows the accessibility service to provide accessibility features to various different games, through instructions generated by machine learning models, without requiring individual games to natively implement accessibility features. In doing so, the accessibility systems provided herein can be leveraged to greatly expand the use of accessibility features across the gaming market, making games more inclusive to all users regardless of an individual user's specific needs or abilities.

In examples, a generative multimodal machine learning model processes may be employed to generates multimodal output. For example, a conversational agent according to aspects described herein may receive user input, such that the user input may be processed using the generative multimodal machine learning model to generate multimodal output. The multimodal output may comprise natural language output and/or programmatic output, among other examples. The multimodal output may be processed and used to affect the state of an associated application. For example, at least a part of the multimodal output may be executed or may be used to call an application programming interface (API) of the application. A generative multimodal machine learning model (also generally referred to herein as a multimodal machine learning model) used according to aspects described herein may be a generative transformer model, in some examples. In some instances, explicit and/or implicit feedback may be processed to improve the performance of multimodal machine learning model.

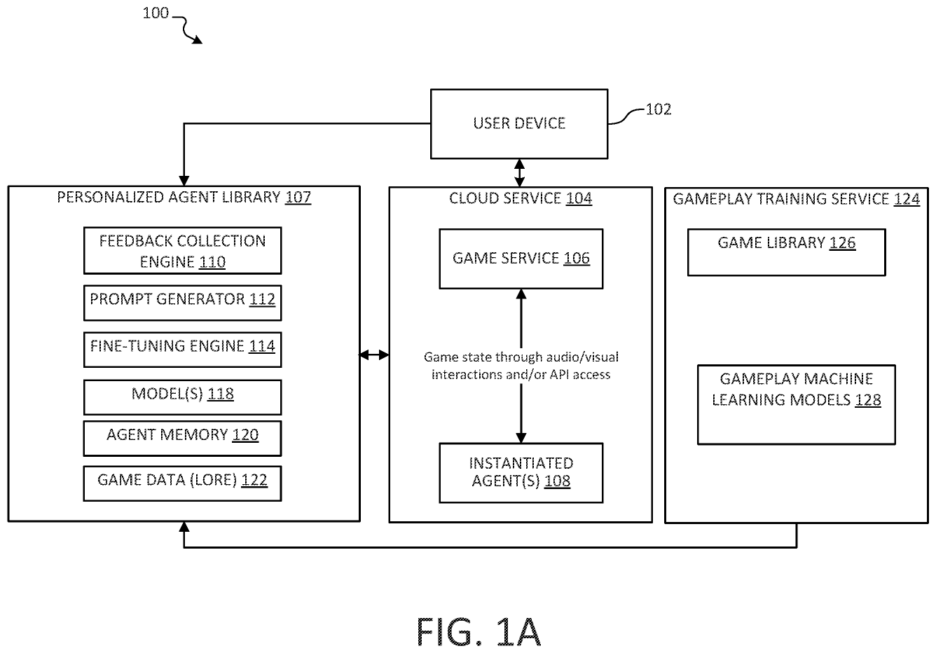

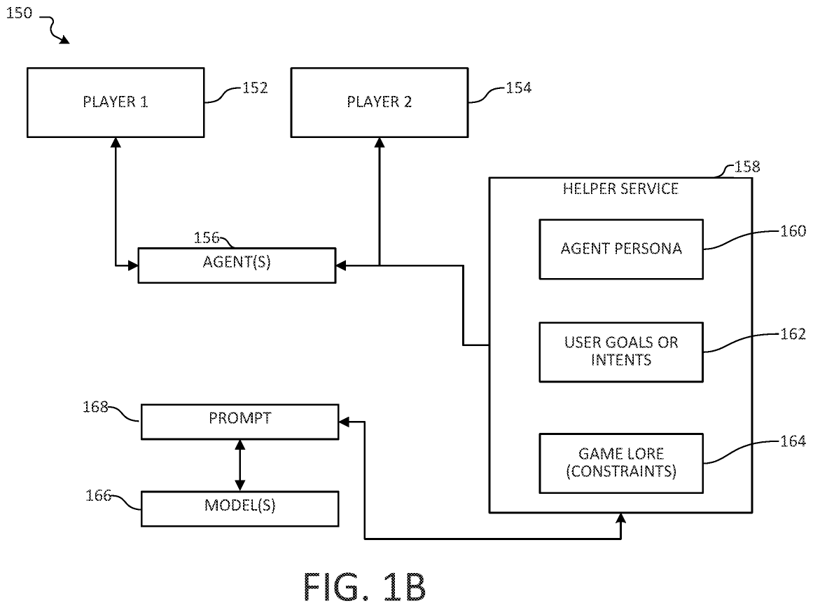

FIG. 1 illustrates an overview of an example system 100 for generating and using user personalized agents in a gaming system. As depicted in FIG. 1, a user device 102 interacts with a cloud service 104 which hosts game service 106 (or other type of application) and an instantiation of an agent 108 that is capable of interacting with the game. A gaming device may be a console gaming system, a mobile device, a smartphone, a personal computer, or any other type of device capable of executing a game locally or accessing a hosted game on a server. In one example, a game associated with the game service 106 may be hosted directly by the cloud service 104. In an alternate example, the user device may host and execute a game locally, in which case the game service 106 may serve as an interface facilitating communications between one or more instantiated agents 108 and the game. The personalized agent library 107 may store and execute components for one or more agents associated with a user of user device 102. The components of the personalized agent library 107 may be used to control the instantiated agent(s) 108.

In example, one or more agents from the personalized agent library 107 interact with the game via an instantiated agent(s) 108 based upon text communications, voice commands, and/or player actions received from the user device 102. That is, system 100 supports interactions with agents as if they were other human players, or alternatively, as a player would normally interact with a conventional in-game NPC. In doing so, one or more agents hosted by the agent library 108 are operable to interact with different games that the user plays without requiring changes to the game. That is, system 100 is operable to work with games without requiring the games to be specifically developed to support the agents (e.g., the agents do not require API access, games do not have to be developed with specific code to interact with the agents, etc.). In doing so, system 100 provides a scalable solution which allows users to play with customized agents across a variety of different games. That is, game state is communicated between one or more instantiated agents 108 a game via game service 106 using audio and visual interactions and/or an exposed API. In doing so, the instantiated agent(s) 108 are able to interact with the game in the same manner as a user (e.g., by interpreting video, audio, and/or haptic feedback from the game) and/or in the same manner as an in-game NPC (e.g., via the exposed API). Similarly, the one or more agents are capable of interacting with the user playing the game using gaming device 102 as another player would or in a manner similar to an NPC interacting with the user. That is, the one or more agents are capable of receiving visual, textual, or voice input from the user playing the game via game service 106 and/or game information (e.g., current game state, NPC inventory, NPC abilities, etc.) via an exposed API. As such, the system 100 allows the user playing the game via the user device 102 to interact with the one or more agents as they would interact with any other player on NPC, however, the instantiated agent(s) 108 may be personalized to the user based upon past interactions with the user that occurred both in the current game and in other games. In order to facilitate this type of user interaction, the one or more instantiated agents 108 may employ computer vision, speech recognition, or other known techniques when processing interactions with the user in order to interpret commands received from the user and/or generate a response action based upon the user's actions.

For example, consider a user playing a first-person shooter with a personalized agent. The user may say “cover the right side.” A speech recognition model that may be one of the models 118 may be utilized to interpret the audio received from the user to a modality understood by the agent. In response, the agent 108 may take a position on the right side of the user or otherwise perform an action to cover the right side of the user in response to the user's audio instruction. As yet another example, consider an action role playing game in which two objectives must simultaneously be defended. An agent playing in conjunction with the user may employ computer vision to analyze a view current view of the game to determine that two objectives exist (e.g., identifying two objectives on a map, interpreting a displayed quest log indicating that two objectives must be defended, etc.). Similarly, computer vision may be used to identify the user's player character and determine the player character is heading to the first objective. Based upon the feedback from the computer vision model, the agent can instruct its representative character to move towards and defend the second objective.

From these examples, one of skill in the art will appreciate that, by employing speech recognition, computer vision techniques, and the like, the one or more agents from the agent library will be able to interact with the user in a manner similar to how other users would interact during cooperative gameplay. In doing so, one or more agents from the agent library can be generated separate from a specific game as the instantiated agent(s) 108 may not have to have API or programmatic access to the game in order to interact with the user. Alternatively, the instantiated agent(s) 108 may have API access or programmatic access to the game, such as, when the instantiated agent is “possessing” and in-game NPC. In said circumstances, the agent may interact with the game state and user based via the API access. Because system 100 provides a solution in which agents can be implemented separate from the individual games, the one or more agents in the agent library can be personalized to interact with a specific user. This personalization can be carried across different games. That is, over time, the agent learns details about the user, such as the user's likes and dislikes, the user's playstyles, the user's communication patterns, user's preferred strategies, etc., and be able to accommodate the user accordingly across different games.

The agent personalization may be generated, and updated over time, via the feedback collection engine 110. Feedback collection engine 110 receives feedback from the user and/or from the instantiated agent(s) 108 that are performed in-game. The feedback collected can include information related to the user's playstyle, user communication, user interaction with the game, user interaction with other players, user interaction with other agents, outcomes of the instantiated agent(s) 108 actions performed in game, interactions between the player and the instantiated agent(s) 108 actions in game or any type of information generated by user device 102 as a user plays a game. In order to comply with user privacy considerations, information may only be collected by the feedback collection engine 110 upon receiving permission from the user to do so. The user may opt in or out of said collection at any time. The data collected may be implicit data, e.g., data based upon the user's normal interactions with the game, or explicit data, such as specific commands provided by the user to the system. An example of a specific command may be the user instructing an agent to address the user by a specific character name. Data collected by the feedback collection engine 110 may be provided to a prompt generator 112.

The prompt generator 112 may use data collected by the feedback collection engine 110 to generate prompts used to personalize the one or more agents of the agent library 108. That is, the prompt generator 112 interprets the collected feedback data to generate instructions that can be executed by the one or more agents to perform actions by the agent. The prompt generator is operable to generate new prompts or instructions based upon the collected feedback or alter existing prompts based upon newly collected feedback. For example, if a user initially plays a game as a front-line attacker, prompt generator 112 may generate instructions that cause the instantiated agent(s) 108 to implement a supporting playstyle, such as being a ranged attacker or a support character. If the user transitions playstyle to one of a ranged damage dealer, the prompt generator 112 can identify this change via the feedback data and adjust the instantiated agent(s) to adjust to the player's new style (e.g., switch to a front-line attacker to pull aggro or enmity from the player character). Instructions generated by the prompt generator are provided to the cloud service 104 to be stored by the cloud service 104 as part of the agent library 108, thereby storing meta classifications (e.g., sentiment analysis, intent analysis, etc.) associated with a specific user. In doing so, the instructions generated based upon user playstyle or preference in a first game can be incorporated by the agent in not only the first game, but other games that the user plays. That is, using instructions generated by the prompt generator 112, the cloud service 104 can instantiate agents that across a variety of different games that are already personalized for a specific user based upon the user's prior interactions with an instantiated agent(s) 108, regardless of whether the user is playing the same game or a different game. While aspects described herein describe a separate prompt generator 112 as generating commands to control the instantiated agent(s) 108, in alternate aspects, the commands may be generated directly by the one or more machine learning models employed by the agent library 107, or via a combination of various different components disclosed herein.

In some scenarios, however, there may be issues encountered during the training process for the various machine learning models that may be leveraged to generate a personalized agent. For example, there could be a failed training session due to data or processing errors. In yet another example, the training process may fail due to user error. For example, a user picking up a new game may play the game incorrectly at first. The user's incorrect actions or experiences might train the personalized agent to play in a manner that negatively affects gameplay. As such, system 100 may include processes to rollback or reset the one or more machine learning models (or any of the other components disclosed herein) in order to correct errors that may occur while training the one or more machine learning models or any other errors that may occur in general as the personalized agent is developed. For example, the system 100 may periodically maintain a snapshot of the different machine learning models (or other components) that save the state of the component at the time of the snapshot. This allows the system 100 to rollback all the components, a subset of components, or specific components in response to detecting training errors in the future. A plurality of different snapshots can be store representing states of the personalized agent as it develops overtime, thereby providing the system 100 (or the user) options to determine an appropriate state for rollback upon encountering an error.

The personalized agent library 107 may also include a fine-tuning engine 114 and one or more models 116. The fine-tuning engine 114 and models 116 are operable to interact with the user actions via the user device 102, the instantiated agent(s) 108, and game training model(s) 124 in order to process the feedback data received form the various sources. Any number of different models may be employed individually or in combination for use with the examples disclosed herein. For example, foundation models, language models, computer vision models, speech models, video models, and/or audio models may be employed by the system 100. As used herein, a foundation model is a model trained on broad data that can be adapted to a wide range of tasks (e.g., models capable of processing various different tasks or modalities).

The one or more models 116 may process video, audio, and/or textual data received from the user or generated by the game during gameplay in order to interpret user commands and/or derive user intent based upon the user communications or in-game actions. The output from the one or more models 116 is provided to the fine-tuning model 114 which can use the output to modify the prompts generated by prompt generator 112 in order to further personalize the instructions generated for the user based upon the agent's past interactions with the user. The Personalized agent library 107 may also include a game data (lore) 122 component which is operable to store information about various different games. The game data (lore) 122 component stores information about a game, the game's lore, story elements, available abilities and/or items, etc. that the agent can be utilized by the other components (e.g., models 118, fine-tuning engine 114, prompt generator 112, etc.) to generate instructions to control the instantiated agent(s) 108 in accordance with the game's themes, story, requirements, etc.

The various components described herein may be leveraged to interpret current game states based upon data received from the game (e.g., visual data, audio data, haptic feedback data, data exposed by the game through APIs, etc.). Further, the components disclosed herein are operable to generate instructions to control the personalized agent's actions in game based upon the current game state. For example, the components disclosed herein may be operable to generate instructions to control the personalized agent's interaction with the game in a similar manner as a human would interact with the game (e.g., by providing specific controller instructions, keyboard instructions, or any other type of interfaces with supported gameplay controls). Alternatively, or additionally, the various components may generate code which controls how the personalized agent interacts in the game. For example, the code may be executed by the personalized agent which causes the personalized agent to perform specific actions within the game.

Personalized agent library 107 may also include an agent memory component 120. The agent memory component can be used to store personalized data generated by the various other components described herein as well as playstyles, techniques, and interactions learned by the agent via past interactions with the user. The agent memory 120 may provide additional inputs to the prompt generator 112 that can be used to determine the instantiated agent(s) actions during gameplay.

To this point, the described components of system 100 have focused on the creation of personalized agents, the continued evolution of personalized agents via continued interaction with a user, and the instantiation of personalized agents in a user's gaming session. While personalization of the agents for specific user provides many gameplay benefits, the instantiated agents also require and understanding of how to interact with and play the game. In one aspect, the components of the personalized agent library 107 are operable to learn and refine the agent's gameplay based upon sessions with the user. However, when the user plays a new game, the time required for the agent to learn gameplay mechanics in order to be a useful companion may not be feasible through gameplay with the user alone. In order to address this issue, system 100 also includes a gameplay training service 124 which includes a game library 126 and gameplay machine learning models 128. In aspects, the game library includes any number of games that are supported by the cloud service 104 and/or the user device 102. The gameplay training service 124 is operable to execute sessions for the various games stored in game library 126 and instantiate agents within the executed game. The gameplay machine learning models 128 are operable to receive data from the executed game and the agent's actions performed in the game as input and, in response, and generate control signals to direct the gameplay of the agent within the game. Through use of reinforcement learning, the gameplay machine learning models are operable to develop an understanding of gameplay mechanics for both specific games and genres of games. In doing so, the gameplay training service 124 provides a mechanism in which agents can be trained to play specific games, or specific types of games, without requiring user interaction. The personalized agent library 107 is operable to receive trained models (or interact with the trained models) from the gameplay training service 124, which may be stored as part of the agent memory, and employ those models with the other personalization components to control the instantiated agent(s) 108. In doing so, the user experience interacting with the agent in-game is greatly enhanced, as the user would not be required to invest the time to train the agent in the game's specific mechanics. Additionally, by importing or interacting with the trained gameplay machine learning models 128 provided by the gameplay training service 124, personalized agent library 107 is able to employ trained instantiated agent(s) 108 to play with the user the first time a user boots up a new game.

One of skill in the art will appreciate that the system 100 provides a personalized agent, or artificial intelligence, that is operable to learn a player's identity, learn a player communication style or tendencies, learn the strategies that are employed and used by a player in various different games and scenarios, learn gameplay mechanics for specific games and game genre's etc. Further, the one or more agents generated by system 100 can be stored as part of a cloud service which allows the system to retain a “memory” of a user's past interactions, thereby allowing the system to generate agents that act as a consistent user companion across different games without requiring games to be designed specifically to support such agents.

FIG. 1B illustrates on overview of an example system 150 for generating and utilizing personalized agent responses in a gaming system. As depicted in system 150, two players, player 1 152 and player 2 154 are interacting with one or more agents 156. Although two players are shown, one of skill in the art will appreciate that the any number of players can participate in a gaming session using system 150. A helper service 158 is provided which helps personalize the one or more agents 158 interactions with the individual players, or with multiple players simultaneously. As discussed in FIG. 1A, one or more models 166 may be used to generate or modify prompts 168. The prompts 168 are provided to the helper service 158, which applies a number of engines (e.g., agent persona engine 160, user goals or intents engine 162, and game lore or constraints engine 164) to modify the prompt to provide a more personalized interaction with the individual or group of players.

For example, agent persona engine 160 may modify or adjust a prompt (or action determined by a prompt) in accordance with the personalization information associated with the agent. For example, the user may employ an agent with a preferred personality. Agent persona engine 160 may modify the prompt or response to generated by the prompt in accordance with the agent's personality. User intent or goals engine may modify the prompt (or action determined by the prompt) based upon the user's current goal or an intent behind the user's action or request. The user's goals or intent may change over time, may be based upon a specified user goal, or may be determined based upon the user's actions. Game lore or constraints engine 164 may modify or adjust a prompt (or action determined by a prompt) in accordance with characteristics of the game. For example, the agent may be “possessing” an in-game non-player character (as discussed in further detail below). The game lore or constraints engine 164 may modify the prompt based upon the NPCs personality or limitations. The various engines of the helper service may be employed individually or in combination when modifying or adjusting the prompts. The adjusted prompt is then provided to the one or more associated agents 156 for execution.

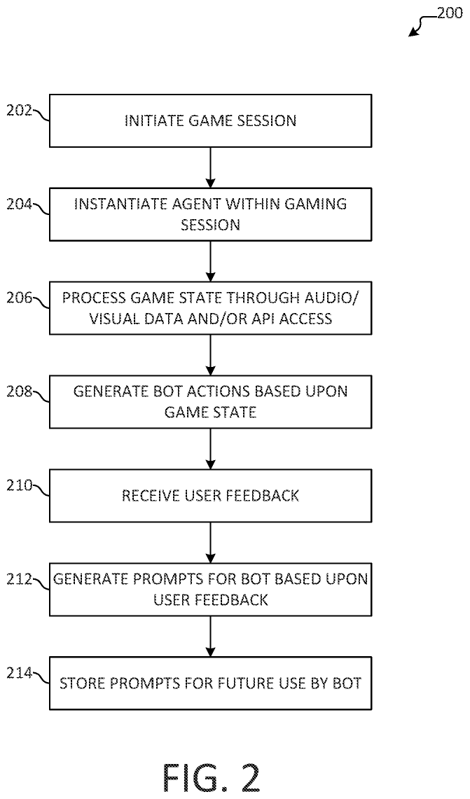

FIG. 2 illustrates an example of a method 200 for generating personalized agents. For example, the method 200 may be employed by the system 100. Flow beings at operation 202 where a game session is instantiated, or an indication of a game session being instantiated is received. As noted above, the game session may be hosted by the system performing the method 200 or may be hosted by a user device, such as on a gaming console. Upon instantiating the game or receiving an indication that a game session is established, flow continues to operation 204 where an agent is instantiated as part of a game session. In one example, the agent may be instantiated in response to receiving a request to add the agent to the game session. For example, a request may be received to instantiate an agent in a multiplayer game or an agent to control an NPC or AI companion in a single player game. Instantiating the agent may comprise identifying an agent from an agent library associated with the user playing the game. As noted above, aspects of the present disclosure provide for generating agents that can be played across different games. As such, the agent instantiated at operation 204 may be instantiated using various components that are stored as part of a personalized agent library. For example, the agent may be instantiated using personalization characteristics learned overtime through interactions with the play, game data or lore saved regarding a specific game or genre, machine learning models trained to perform mechanics and actions specific to the game in which the agent is to be instantiated or trained based upon a similar genre of game as the game in which the agent is to be instantiated, etc. As discussed previously, the selected agent may be personalized to the user playing the game based upon past interactions with the user in the same game as the one initiated at operation 202 or a different game. Alternatively, rather than instantiating an agent dynamically using different component stored in the agent library, a specific agent may be selected at operation 204. That is, the agent library may contain specific “builds” for different types of agents that were designed by the user or derived though specific gameplay with the user. These agents may be saved and instantiated by the user in future gaming sessions for the same game as they were initially created or in different games. Upon instantiating the agent at operation 204, the agent joins the gaming session with the user.

At operation 206, the current game state is interpreted through audio and visual data and/or through API access granted to the agent by the game. As previously noted, certain aspects of the disclosure provide for the generation of agents that can interact with a game without requiring API or programmatic access to the game. As such, the instantiated agent interacts with the game in the same way a user would, that is, through audio and visual data associated with the game. Alternatively, the agent may be granted API access to the game, for example, when the agent is possessing an NPC, in order to interact with the game. At operation 206, various speech recognition, computer vision, object detection, OCR processes, or the like, may be employed to process communications received from the player (e.g., spoken commands, text-based commands) and game state through the current displayed view (e.g., using computer vision) or via an API to interpret game state. The current game state is then used to generate agent actions at operation 208. For example, an agent action may be performed based upon a spoken command received from the user. Alternatively, an agent command may be generated based upon the current view. For example, if an enemy appears on screen, computer vision and/or object detection may be used to identify the enemy, and a command for the agent to attack the enemy may be generated at operation 208. Although not shown, operations 206 and 208 may be continually performed while the gaming session is active.

Flow continues to operation 210 where user feedback is received. The user feedback received may be explicit. For example, the user may issue a specific command to an agent to perform an action or to change the action they are currently performing. Alternatively, or additionally, user feedback may be implicit. Implicit user feedback may be feedback data that is generated based upon user interactions with the game. For example, the user may not explicitly provide a command to an agent, rather, the user may adjust their actions or playstyle based upon the current game state and/or in response to an action performed by the agent. In examples, user feedback may be collected continually during the gaming session. The collected feedback may be associated with concurrent game states or agent actions.

Upon collecting the user feedback, flow continues to operation 212 where prompts are generated for the one or more agents based upon the user feedback. In examples, the generated prompts are instructions to perform agent actions in response to the state of the game or specific user interactions. The prompts may be generated using one or more machine learning models which receives the user feedback, and/or actions performed by the one or more agents, and/or existing prompts, and/or state data. The output of the machine learning model may be used to generate one or more prompts. In examples, the machine learning model may be trained using information related to the user such that the output from the machine learning model is personalized for the user. Alternatively, or additionally, the machine learning model may be trained for a specific game or application, for a specific group of users (e.g., an e-sports team), or the like. Multiple machine learning models may be employed at operation 212 to generate the prompts. In still other examples, other processes, such as a rule-based process, may be employed in addition to or instead of the use of machine learning models at operation 212. Further, new prompts may be generated at operation 212 or existing prompts may be modified.

Once the one or more prompts are generated at operation 212, flow continues to operation 214 where the one or more prompts are stored for future use by the one or more agents. For example, the one or more prompts may be stored in an agent library. By storing the prompts generated at 212 with the agent library, the agent will be able to utilize the prompts to interact with the user across different games, thereby providing a personalized agent that a user can play with across different games.

While aspects of the disclosure described so far have related to importing a personalized agent to play with a user, game developers may leverage the systems described herein to provide an accessibility system to help players. That is, the personalized agents can be used to implement accessibility features during a gaming session. For example, aspects disclosed herein may be used to help people with disabilities play a video game. For example, aspects of the present disclosure can be leveraged to help those who are visually impaired, colorblind, those with limb loss which may affect gameplay, or to help novice gamers learn to play new games.

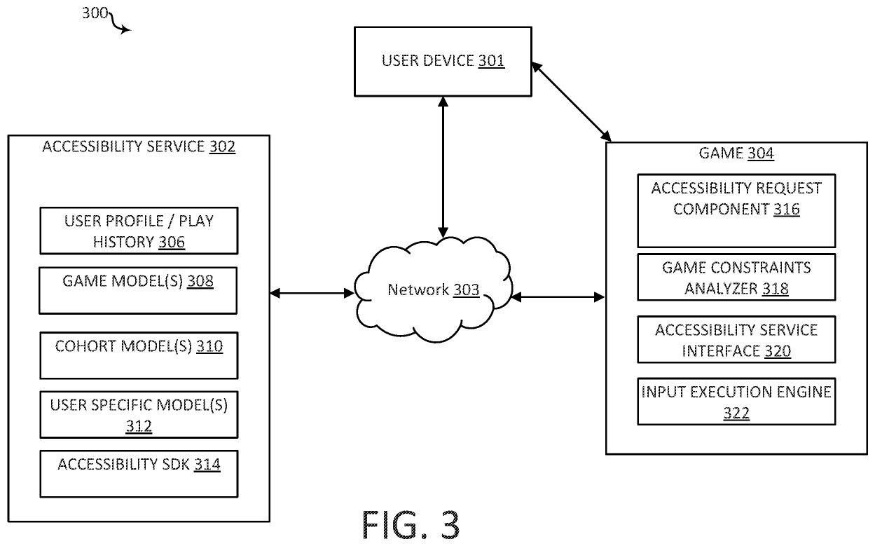

FIG. 3 depicts an exemplary system 300 for providing an accessibility service 302 using one or more machine learning models. As depicted in system 300, accessibility service 302 may communicate with a game 304 that is executing on or controlled via a user device. In examples, the game 304 may be executed locally on a user device (such as a gaming console, a PC, a smartphone, etc.) or on a cloud service network. When the game 304 is executed on a cloud service, a user may still control gameplay via the local device 301 (e.g., a controller, a game console, a PC, etc.). In some instances, the user device 301, the game 304, and the accessibility service 302 may all be executed locally on a single device (e.g., a game console or PC). However, as shown in FIG. 3, the user device 301, game 304, and accessibility service may be executed on different devices which are connected via a network 303. The network 303 may be a local area network, a wide area network, the Internet, or any other type of network. In some aspects, the accessibility service 302 may be hosted using a cloud network or a distributed network. For example, the accessibility service may utilize one or more machine learning models which may require computing resources not available to the user device.

The accessibility service 302 may include various data repositories, machine learning models, and/or executable code which allows the accessibility service to provide accessibility features to a game. That is, the accessibility service 302 may be a service that a game 304 can leverage, without requiring individual games to implement features of the service. For example, the accessibility service 302 may provide an accessibility SDK that a game, such as game 304, can leverage to incorporate accessibility features without requiring the game developers to implement said accessibility features into the game. As such, accessibility service 302 is a service that can be leveraged by various different games to provide accessibility features, thereby creating a gaming ecosystem which is more inclusive to users with disabilities.

In one aspect, the accessibility service 302 may include a user profile data and/or data related to play history. For example, if a user provides permissions for the accessibility service 302 to do so, the accessibility service 302 may collect and store user profile/play history information 306 related to user's accessibility preferences (e.g., colorblind mode enabled, one-handed mode enabled, etc.), game preferences (e.g., level of difficulty, playstyle preferences, etc.), and the like. In further aspects, the user profile/play history information 306 may track the user's playstyle, abilities, and performance related to the different games. The user profile/play history information 306 may be tracked across different games played by the user, thereby providing a baseline of information and preferences that can be leveraged by the accessibility service 302 when implementing accessibility features for the user as they play different and new games.

Accessibility service 302 may also include one or more game model(s) 308. The one or more game model(s) 308 may be any type of machine learning model that is generated for, trained for, or fine-tuned for as specific game. That is, the accessibility service 302 may have one or more specific machine learning models specific to individual games, or individual game genre's (e.g., first-person shooters, role-playing games, puzzle games, massively multiplayer online role-playing games (MMORPG), etc.). The one or more game model(s) may be any type of machine learning model (e.g., foundation models, language models, computer vision models, speech models, video models, audio models, multimodal machine learning models, etc.). In aspects, the one or more game model(s) 308 may be generated, trained, or fine-tuned to perform gameplay for the specific game (or genre of game) based upon data collected from a general playset, based upon bot simulations, or a combination of both. In examples, the game model(s) 308 represent standard gameplay for a specific game (or genre of game). Further, different game model(s) 308 may be generated to mirror different gameplay abilities (e.g., novice gameplay, advanced gameplay, expert gameplay, etc.). The game model(s) 308 may be used as a baseline gameplay generator by the accessibility service 302 to generate controls to play a specific game (or genre of game) at a desired level of competence.

While the game model(s) 308 can be leveraged by the accessibility service 302 to generate gameplay for a specific game, the game model(s) 308 are general in nature, that is, they are not trained to assist users with particular impairments. In order to provide assistance to players with particular impairments (e.g., visually impaired, missing limbs, etc.) the accessibility service includes one or more cohort model(s) 310. While the game model(s) 308 are generated, trained, ore fine-tuned to generate gameplay commands based upon a general userbase, the cohort model(s) 310 may be one or more machine learning models (e.g., foundation models, language models, computer vision models, speech models, video models, audio models, multimodal machine learning models, etc.) that are generated, trained, or fine-tuned to generate gameplay commands that can assist users with a specific impairment (e.g., a cohort of an impaired user). For example, specific cohort model(s) 308 may exist to generate gameplay commands specific to assist user's with a particular impairment (e.g., colorblind, visually impaired, one-handed play, etc.). The cohort model(s) 310 may be generated or trained using a dataset of gameplay from users with a particular impairment and, as such, may generate gameplay commands that are specifically tailored to assist a user with a particular impairment. While aspects have been described as including different models for specific impairments, one of skill in the art will appreciate that a single model may be generated, trained, or fine-tuned to generate gameplay commands to assist with multiple impairments.

The accessibility service 302 may also include user specific model(s) 312. For example, provided that an individual user provided the accessibility service to collect data about the individual user's gameplay, one or more machine learning models (e.g., foundation models, language models, computer vision models, speech models, video models, audio models, multimodal machine learning models, etc.) that are specific to the individual user's gameplay. These user specific model(s) 312 may be generated using individual data from other gaming sessions (e.g., data from user profile/play history 306) or from past gaming sessions for a currently played game (e.g., game 304). Further, user specific model(s) 312 may be continually updated based upon the individual user's gameplay, thereby reacting to improvements the individual user makes as they continue to play the game and increase their skill with a particular game (or genre of game). Similar to the other machine learning models (e.g., game models, cohort models, etc.) the user specific model(s) 312 may receive game data (e.g., game state, user input during gameplay, etc.) and generate gameplay assist commands specific to the user.

The exchange of gameplay data and accessibility commands can be facilitated through the accessibility SDK 314. As noted earlier, the accessibility SDK 314 exposes the accessibility service 302 to different games, such as game 304, in order to allow the games to provide accessibility features, using one or more machine learning models, without the need to individually implement the accessibility features within the game itself. Thus, developers can add accessibility features to games easily, thereby creating a more inclusive gaming environment. Via the accessibility SDK 314, gameplay data, user inputs, and assistance controls generated by the accessibility service can transmitted and received during a gameplay session.

In an exemplary operation, the various machine learning models of the accessibility service (e.g., game model(s) 308, cohort model(s) 310, and user specific model(s) 314) may receive current gameplay data for the game 304 and generate assist commands to help an impaired user play the game as the impaired user plays. In one example, one or more of the various types of machine learning models may receive gameplay data, including, for example, current game state, current user display (e.g., the user's current view), commands input by the user, etc. as input which is processed using the machine learning model(s) to generate commands that can assist the user in controlling the game. In one aspect, these models may make individual determinations which can be input to the other models (along with the gameplay data mentioned above, for example) to generate commands that are specific to assist the user based upon the user's impairment. For example, a game model 308 may receive game play data to generate a generic command (e.g., a command based upon the overall set of users). The generic command may be provided, with or without gameplay data, to a cohort model, which may generate a command tailored to assist a user with a similar impairment as the user playing the game 304 via user device 301. The tailored command may then be provided as input, with or without gameplay data, to the user specific model which can then generate a user specific command (e.g., tailored based upon the user's specific needs or preferences). The user specific command may then be provided to the game, for example, via network 303, to be implemented along with the user's input, in order to assist the user playing the game. One of skill in the art will appreciate that the type of assist may change depending upon the individual user's needs, current gameplay, gameplay restrictions, and/or current state of the game. In doing so, the accessibility service 302 is operable to provide any number of different assistance features (e.g., aim assist, object detection, gameplay hints, assisted steering or driving controls, additional button inputs) based upon the user's needs and preferences. Further, while aspects described herein teach the use of multiple machine learning models, one of skill in the art will appreciate that a single machine learning model can be implemented to perform the features of the different types of models described above. As such, one of skill in the art will appreciate that the differentiation between the different models is provided for ease of illustration and description of the various features provided by the accessibility service and that the disclosure is not limited to an implementation that uses multiple, different machine learning models.

Turning now to game 304, the game 304 may include various components that can be used to interface with the accessibility service 320 and/or implement the assistance controls received from the accessibility service 302. For example, the game 304 may include an accessibility request component 316, a game constraints analyzer 318, an accessibility service interface 320, and input execution engine 322. In one aspect, these various components may be implemented as part of the game to give the game developers control over the extent to which the accessibility commands provided by the accessibility service 302 can control the gameplay. For example, in some situations, such as competitive multiplayer, the game developers may want to limit the amount of control the accessibility service 302 can assert over gameplay in order to ensure that a fair competitive environment exits. However, the functions described as being performed by the game 304 in system 300 may, in other implementations, also be performed by the accessibility service 302. That is, while specific functionality is described as being performed by specific actors in system 300, the functionality can be performed using different actors without departing from the scope of this disclosure.

Accessibility request component 316 may, for example, using calls to the accessibility SDK 314, request a listing of accessibility features that can be provided to the game. For example, upon start-up, the game 304 may query the accessibility service 302 to receive a listing of accessibility features available. The listing of features may be incorporated into a game menu. The game 304 can display the accessibility features in the game to the user. Via this menu user interface, the game 304 may receive a selection of accessibility features to employ from the user (e.g., colorblind mode, tutorial hints, drive assistance, aim assistance, etc.). The selected accessibility features can then be implemented during gameplay. For example, the game may send the selected accessibility features to the accessibility service 302, thereby instructing the accessibility service to generate controls to implement the selected features during gameplay. When a user has previously selected the accessibility features, the selected features may be stored and loaded upon subsequent game sessions, thereby instructing the accessibility service 302 to provide the features without requiring the user to reselect desired features every time the user starts up the game 304. In aspects, the commands received from the accessibility service 302 may be of various different types. For example, the commands may be an input command to help the user control gameplay. Input commands can, for example, relate to aim assistance (e.g., causing the aim to be adjusted during gameplay), driving assistance, extra button input (e.g., for one-handed gameplay), or the like. That is, the commands received from the accessibility service 302 may input commands (e.g., as if they were commands generated using an input device such as a controller, mouse, or keyboard connected to user device 301). Alternatively, or additionally, the commands may be commands to adjust the game environment or provide additional information to the user. Examples of such commands may be commands that cause an object to be highlighted or visually marked (e.g., to help visually impaired users), commands to display hints or tips, or the like. The commands received via the accessibility service interface 320 may be implemented by the game 304.

However, as noted above, a game developer may place limits on the type of commands, the degree of commands, or the type of commands that can be implemented by the accessibility service 302. As such, a game constraints analyzer 318 may be provided which can evaluate the commands received from the accessibility service and determine whether to implement the command, modify the command, or block the command from execution. As noted, there may be reasons in which a game developer would desire to block assistance. For example, during competitive multiplayer games, the game developer may wish to limit or block aim assistance in order to ensure fair gameplay between all players. Alternatively, or additionally, the game developers may wish to block certain hints or tips, as in providing such tips may ruin gameplay for users (e.g., by providing solutions to puzzles, providing information that may spoil upcoming game events, etc.). As such, the game constraints analyzer 318 may analyze received commands against restrictions set up by the game developers, or based upon restrictions set in place by the user, to make sure the accessibility service 302 does not negatively affect gameplay. As noted, in some instances, restricted commands may be blocked by the game constraint analyzer 318 or may be modified in order to comply with game constraints. For example, if the accessibility command is a control command, the game constraints analyzer 318 may modify the control command to adjust the degree of control (e.g., by adjusting the degree of aim assist or steering assist). If the command is to highlight an item in the game, the game constraints analyzer 318 may block the command, or lessen the degree to which the item is highlighted, thereby making is so there is still a degree of assistance but not so obvious as the user playing the game will see it without any effort. Said modifications may take the form of actually modifying the input or graphical commands generated by the accessibility service 302.

Aspects of the present disclosure are directed towards assisting users with gameplay. That said, such assistance is unwelcome to many players when the assistances overwrites the players own actions, thereby removing player agency. That is, the accessibility service 302 is not intended to take over user gameplay, rather to make adjustments to user gameplay in order to assist users who may have an impairment (or may desire additional help otherwise). That is, the commands received by the game from the accessibility service 302 are intended to be used with, not in place of, commands received from the player, that is, commands received from user device 301. As such, an input execution engine 322 is provided to implement gameplay actions based both upon commands received from the user device 301 and the accessibility service 302. For example, if the user is steering a vehicle to the left, and the accessibility command received from the accessibility service is to steer the vehicle to the right, rather than overwriting the user command, the input execution engine may in essence blend the commands, for example, by lessening the degree to which the user command is turning the vehicle to the left, rather than completely overwriting the command. Further, the input execution engine may continually monitor the user commands and compare those commands against the commands generated by the accessibility service 302. If the user commands continue to contradict the commands generated by the accessibility service 302, the input execution engine 322 may end up disregarding the commands generated by the accessibility service 302 altogether, thereby maintaining player agency over control of the game. In said circumstances, the input execution engine may also provide a notification to the user that a certain accessibility feature is enabled that is contradicting the user's input with an option to disable the specific assistance feature via the user interface. In doing so, the system 300 provides a complementary accessibility service, which can be used to assist gameplay without overwriting user actions, thereby maintaining player agency during a gaming session.

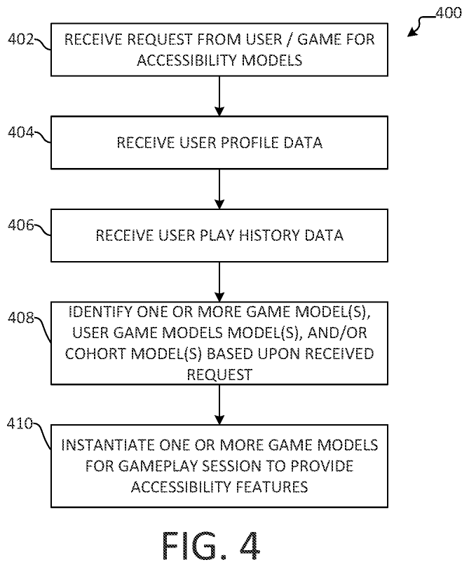

FIG. 4 illustrates an exemplary method 400 for instantiating accessibility machine learning models to assist users during a gameplay session. Flow begins at operation 402 where a request is received from a user or a game to provide accessibility features. For example, a user, interacting via a user interface of a game, such as game 304 (FIG. 3), may select a set of accessibility features to enable for gameplay. Upon receiving the selected accessibility features, the game may transmit a request to an accessibility service, such as accessibility service 302 (FIG. 3) to provide the selected accessibility features. The request is received at operation 402. In one aspect, the request may be received along with a unique identifier for a user, such as the user's gamertag or another unique identifier for the user. Alternatively, or additionally, the request may also include an identifier for the game requesting the accessibility features. Further, the selected accessibility features may be identified using specific features identifiers (e.g., an identifier that corresponds to aim assist, an identifier that corresponds to colorblind mode, etc.). Alternatively, the selected accessibility features may be identified using natural language (e.g., “enable aim assist,” “enable one handed controls,” etc.).

Flow continues to operation 404, where user profile data is received or retrieved. For example, related user profile data stored by the accessibility service may be retrieved for a user based upon the user identifier (e.g., gamertag) associated with the request received at operation 402. The user profile data may include data related to the user's past play history related to a specific game, to a related genre of games, or the like. The profiled data may be stored locally from by the accessibility service or may be requested from the user device, if needed. The user profile data may be used to select specific machine learning models to generate the accessibility features, and/or to generate prompts for one or more selected machine learning models in order to establish context and/or help tune the one or more selected models for the user's gameplay session. Similarly, at operation 406, the user's play history related to the game requesting the accessibility features may be received or retrieved. The user's play history may similarly be used to select specific machine learning models to generate the accessibility feature controls, or to prompt one or more selected machine learning models to generate a particular level of accessibility commands. For example, if the user's gameplay history shows a trend of the user improving their aim over gameplay sessions, the gameplay history received or retrieved at operation 406 may be used to select machine learning models which may provide a smaller degree of aim assistance, or may prompt a selected machine learning model to generate less intrusive aim accessibility commands. As such, the profile data and the play history data received in operation 404 and 406 allow the accessibility service to automatically adjust the degree of assistance (either providing greater or lesser assistance) automatically based upon the user's gameplay history.

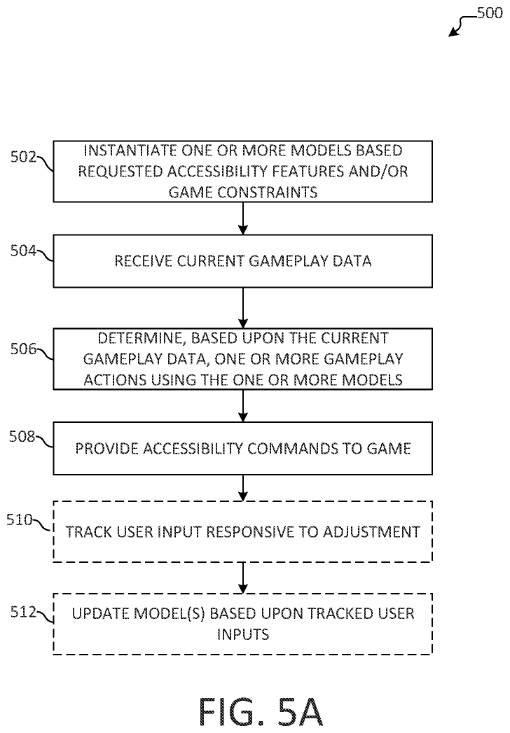

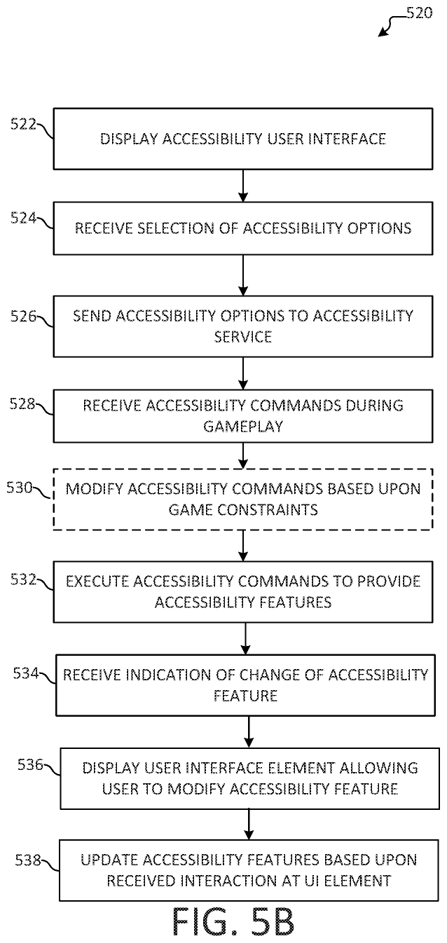

Flow continues to operation 408 where, based upon the received request and/or the received user profile data and play history data, one or more machine learning models are identified to provide the accessibility features. For example, one or more game models, one or more cohort models, and one or more user specific models may be identified by the accessibility service to provide the requested accessibility features. Flow then continues to operation 410 where the selected models are instantiated to provide accessibility features during the gameplay session, as will be described further in FIG. 5A.

The operations of the method 400 may be performed using a single device or multiple devices. For example, the operations may be performed using a single device (such as a PC or gaming console) to generate accessibility features. Alternatively, a user device may interact with a cloud service to perform the operations of method 400. One of skill in the art will appreciate that the operations can be performed using a single or multiple devices, with different operations performed on the different devices, without departing from the scope of this disclosure.

FIG. 5A illustrates an exemplary method 500 for generating accessibility commands using one or more machine learning models. Flow begins at operation 502 where one or more machine learning models are instantiated to provide accessibility features. For example, the process detailed with respect to method 400 may be employed to generate the one or more models. Alternatively, or additionally, specific game constraints can also be used to select the one or more machine learning models. Flow then continues to operation 504, where current gameplay data is received. In one example, the gameplay data may be received via integration with the game via an API, such as via the API exposed by the accessibility SDK described in FIG. 3. Gameplay data may include current game state, current input received by one or more users, environmental information, NPC or other player actions, or any other type of data related to the current gameplay. Alternatively, or additionally, current gameplay data can be received using computer vision. For example, the current view of the game, from the user's perspective, may be provided to a computer vision tool to evaluate a state of gameplay based upon the display alone. In doing so, game play data can be analyzed based upon a view of the game display, thereby generating gameplay data without requiring API access to the underlying game data. As such, aspects of the present disclosure can be provided without requiring access to the game's code or internal game data.

Flow continues to operation 506, where the current gameplay data is analyzed, using the one or more machine learning models, to determine gameplay actions and or game state modifications based upon the selected accessibility features. For example, as previously described, the various machine learning models of the accessibility service (e.g., game model(s), cohort model(s), and user specific model(s)) may receive current gameplay data during gameplay and generate assist commands to help an impaired user play the game as the impaired user plays. In one example, one or more of the various types of machine learning models may receive gameplay data, including, for example, current game state, current user display (e.g., the user's current view), commands input by the user, etc. as input which is processed using the machine learning model(s) to generate commands that can assist the user in controlling the game. In one aspect, these models may make individual determinations which can be input to the other models (along with the gameplay data mentioned above, for example) to generate commands that are specific to assist the user based upon the user's impairment. For example, a game model may receive game play data to generate a generic command (e.g., a command based upon the overall set of users). The generic command may be provided, with or without gameplay data, to a cohort model, which may generate a command tailored to assist a user with a similar impairment as the user playing the game via user device. The tailored command may then be provided as input, with or without gameplay data, to the user specific model which can then generate a user specific command (e.g., tailored based upon the user's specific needs or preferences). The user specific command may then be provided to the game to be implemented along with the user's input, in order to assist the user playing the game. Alternatively, in some aspects, a single machine learning model may be instantiated to provide the assistance features.

The accessibility features, represented by accessibility commands in the form of gameplay commands, game state commands, or a combination of both, are generated using the one or more machine learning models are then provided to the game for execution at operation 508. For example, the commands generated by the one or more machine learning models are provided to the game for execution along with the input received by the user. Flow continues to operation 510 where, optionally, user input made in response to the accessibility features is tracked. As noted, aspects of the present disclosure relate to providing a complementary system to assist user's during gameplay in a manner that does not remove user agency. If a user provides input to contradict the accessibility commands, such as, moving a vehicle or adjusting aim against the commands provided by the one or more machine learning models, then the assistance models may be adjusted to generate commands that are not contradicted by the user. As such, the user's response to the commands may be tracked at operation 510 and stored as potential feedback data. The tracked user input, along with the commands generated by the one or more models, and/or gameplay data, may be saved at operation 510 and used using a fine-tuning or training process to update the one or more models at operation 512. In doing so, the one ore more models may continually be updated using feedback or reinforcement learning, thereby adjusting to user playstyles, preferences, and improvement in play as the user continues to play the game. In doing so, the method 500 provides a mechanism to continually update machine learning models used to provide player assistance to best compliment a user's gameplay.

The operations of the method 500 may be performed using a single device or multiple devices. For example, the operations may be performed using a single device (such as a PC or gaming console) to generate accessibility features. Alternatively, a user device may interact with a cloud service to perform the operations of method 500. One of skill in the art will appreciate that the operations can be performed using a single or multiple devices, with different operations performed on the different devices, without departing from the scope of this disclosure.

FIG. 5B illustrates an exemplary method 520 for implementing accessibility features during gameplay. Flow begins at operation 522 where a user interface is displayed indicating accessibility options that are available for the game. In one example, the accessibility options available may be determined based upon the accessibility features that can be provided by an accessibility service, such as accessibility service 302 of FIG. 3. That is, the accessibility features need not be provided specifically by the game. At operation 524, one or more accessibility options may be selected from the accessibility user interface. The selected options are then sent to the accessibility service at operation 506. The selected accessibility options may be used to generate instantiate one or more machine learning models to provide the accessibility features by the accessibility service, as described herein.

One of skill in the art will appreciate that operations 522 through 526 may be performed dynamically. That is, the accessibility user interface may be called up at any time during gameplay, at which point different accessibility features can be selected. Further, the selected accessibility features can be saved, such that a user is not required to select accessibility features each time the user plays the game. Rather, previously selected accessibility features can be loaded during subsequent game sessions.

Flow continues to operation 520, where accessibility commands are received from an accessibility service. Accessibility commands can take form of gameplay commands (e.g., commands to control player actions during the game), game state commands (e.g., commands to change the state of the game such as game difficulty, the visual state of a game such as highlighting items or adjusting for colorblindness, or provide gameplay tips or hints), or a combination of both. Flow continues to operation 530, where the accessibility commands are optionally modified based upon game constraints. For example, as previously described, the received accessibility commands may be analyzed against restrictions set up by the game developers, or based upon restrictions set in place by the user, to make sure the accessibility service does not negatively affect gameplay. As noted, in some instances, restricted accessibility commands may be blocked or may be modified in order to comply with game constraints. For example, if the accessibility command is a gameplay control command, modify the accessibility command to adjust the degree of control (e.g., by adjusting the degree of aim assist or steering assist). If the command is to highlight an item in the game, the accessibility command may be blocked, or modified to lessen the degree to which the item is highlighted, thereby making is so there is still a degree of assistance but not so obvious as the user playing the game will see it without any effort. Said modifications may take the form of actually modifying the input or graphical commands generated by the accessibility service.

At operation 508, the accessibility commands, either modified or unmodified, are executed by the game. In some instances, execution of the accessibility commands may be performed regardless of user interaction. For example, accessibility commands that change a game display (e.g., highlight objects, provide tips) may be executed regardless of corresponding user input. Gameplay command controls, however, may be executed in conjunction with corresponding user input in a manner that adjusts or complements the received user input as opposed to completely overwriting the received user input. In doing so, the user maintains agency over their gameplay.

The process of receiving, modifying, and executing commands may continue during a gameplay session. However, in some instances, an indication of a change to the assistance commands may be automatically received. For example, if a user continues to adjust against a gameplay feature, e.g., correcting moves made by aim assistance, or if it is determined that some accessibility features are no longer needed, e.g., based upon improvement in user gameplay, an indication of a change of accessibility feature may be received at operation 534. The change may cause the game to display a user interface element at operation 536. The displayed user interface element may provide information about changes to the assistance feature, along with an activatable element which would allow the user to modify or change the accessibility feature, such as, for example, by removing aim assist or adjusting aim assist to be less invasive. Upon receiving selection of the user interface element, flow continues to operation 538 where the accessibility features are updated and corresponding changes are saved and sent to the accessibility service.

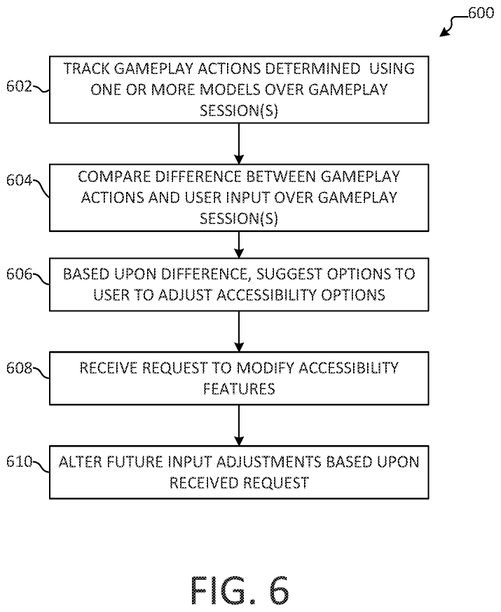

FIG. 6 depicts an exemplary method 600 for modifying accessibility features based upon changes in a user's gameplay. Flow begins at operation 602 where gameplay actions, e.g., accessibility commands, determined by one or more machine learning models are tracked during gameplay along with actions that the user made in response to the accessibility commands. At operation 604, the user actions are compared to the gameplay actions (e.g., accessibility commands) to determine differences between the accessibility commands and the user input. For example, the accessibility commands may be compared to the user input to determine a degree in difference between actions generated by the machine learning models and the user input. If the degree in difference is below a threshold, then a determination may be made that the user no longer needs a specific type of assistance. Alternatively, or additionally, if the degree of difference between the actions generated by the machine learning models and the user input is relatively high, or if subsequent input received by the user indicates that the user is compensating against model generated actions, then it can be determined that the user does not agree with the suggested actions. In said instances, a determination may be made to modify the level of assistance provided, or to disable an accessibility feature altogether.

At operation 606, one or more suggestions to modify an accessibility option may be generated based upon the determined difference. The suggested adjustment may displayed, along with an interactive user interface element (as described in FIG. 5B) which will allow the user to select the modification. At operation 608, a request to modify the accessibility feature in accordance with the suggested action may be received via the user interface element. In some instances, the updated selection may be transmitted from the game to an accessibility service. At operation 610, future accessibility commands may be generated based upon the updated accessibility features.

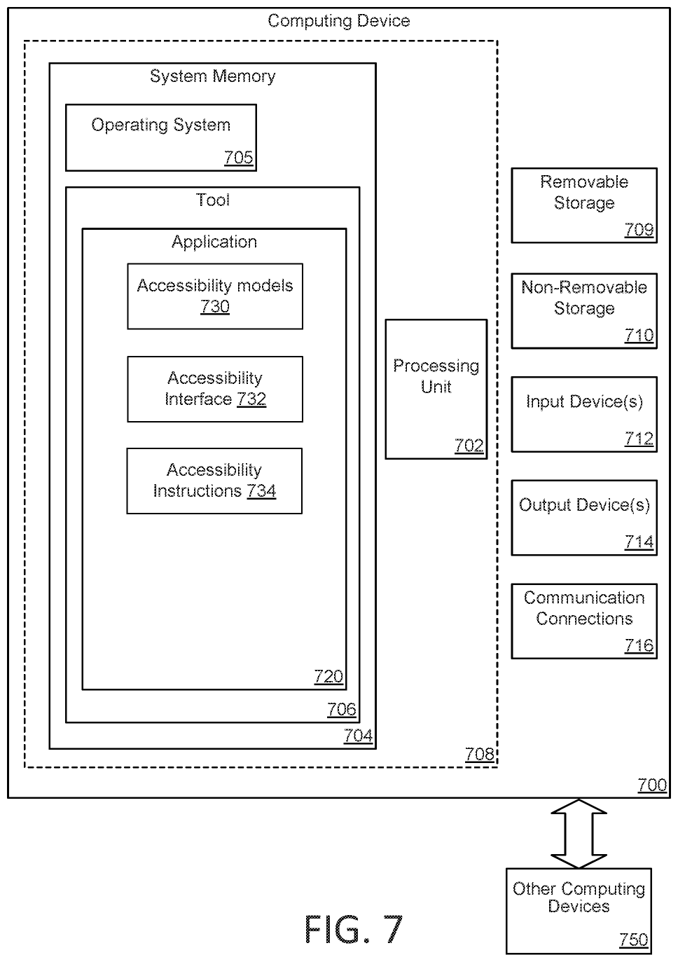

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program tools 706 suitable for performing the various aspects disclosed herein such. The operating system 705, for example, may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program tools and data files may be stored in the system memory 704. While executing on the at least one processing unit 702, the program tools 706 (e.g., an application 720) may perform processes including, but not limited to, the aspects, as described herein. The application 720 includes accessibility models 730, accessibility user interface 732, the accessibility instructions 734 disclosed herein, as well as instructions to perform the various processes disclosed herein. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712, such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of the communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

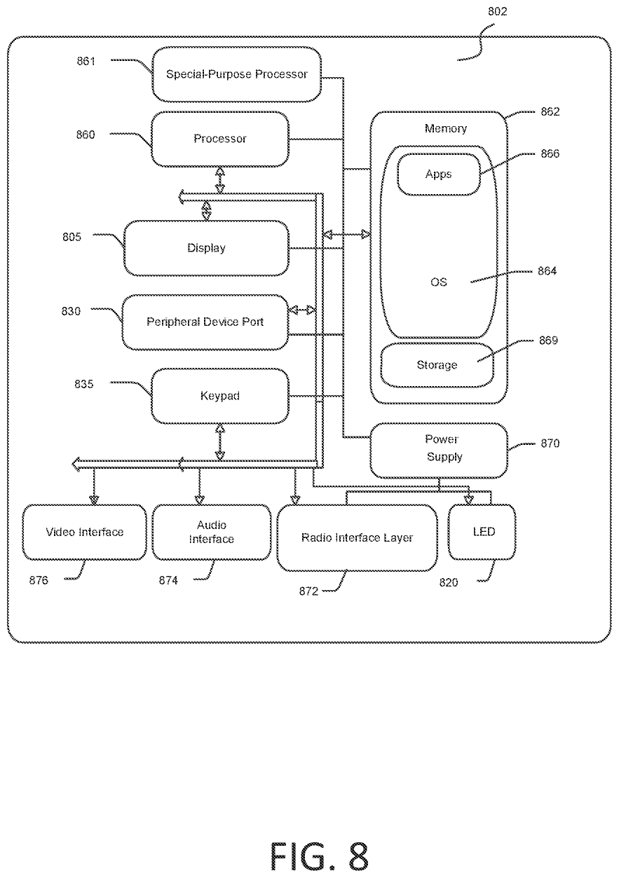

FIG. 8 illustrate a computing device or mobile computing device 800, for example, a mobile telephone, a smart phone, wearable computer (such as a smart watch), a tablet computer, a laptop computer, and the like, with which aspects of the disclosure may be practiced. In some aspects, the client utilized by a user (e.g., the client device 102 as shown in the system 100 in FIG. 1) may be a mobile computing device. FIG. 8 is a block diagram illustrating the architecture of one aspect of computing device, a server, a mobile computing device, etc. That is, the mobile computing device 800 can incorporate a system 802 (e.g., a system architecture) to implement some aspects. The system 802 can implemented as a “smart phone” capable of running one or more applications (e.g., browser, e-mail, calendaring, contact managers, messaging clients, games, and media clients/players). In some aspects, the system 802 is integrated as a computing device, such as an integrated digital assistant (PDA) and wireless phone.

One or more application programs 866 may be loaded into the memory 862 and run on or in association with the operating system 864. Examples of the application programs include phone dialer programs, e-mail programs, information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 (e.g., LED) may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of devices connected to a peripheral device port 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As will be understood from the foregoing disclosure, one aspect of the technology relates to a computer-implemented method for providing accessibility features for a game using an accessibility service, the method comprising: receiving a selection of an accessibility feature for the game; based upon the accessibility feature, instantiating one or more machine learning model, wherein the one or more machine learning model is operable to generate commands to implement the accessibility feature; receiving current gameplay data; generating, using the one or more machine learning models, an accessibility command, wherein the current gameplay data is provided as an input to the one or more machine learning models; and providing the accessibility command to the game, wherein providing the accessibility command causes implementation of the accessibility feature during gameplay.

In an example, the gameplay data comprises one or more of: current user input; game state information; information about other player characters; or non-player character information.

In another example, receiving current gameplay data comprises receiving a current view of the game, wherein the current view of the game is the view depicted to a player during gameplay.

In yet another example, current gameplay data further comprises, processing the current view of the game, using computer vision, to generate gameplay data.

In a further still example, instantiating one or more machine learning models comprises instantiating at least one of: a game machine learning model; a cohort machine learning model; or a user specific machine learning model.

In a further example, the cohort machine learning model trained to generate accessibility commands for a specific impairment.

In still a further example, the computer-implemented method further comprising, in response to providing the accessibility command, receiving user input responsive to an adjustment made by the accessibility command.

In another example, the computer-implemented method further comprising, updating the one or more machine learning models based upon the user input responsive to the adjustment made by the accessibility command.

In another aspect, the technology relates to a computer-implemented method for proving an accessibility user interface for a game based upon accessibility features provided by an accessibility service, the method comprising: generating a user interface depicting a plurality of accessibility features, wherein the plurality of accessibility features comprise accessibility features provided by the accessibility service, and wherein the accessibility service is a service separate from the game; receiving a selection of a first accessibility feature provided by the accessibility service; sending the first accessibility feature to the accessibility service; and in response to sending the accessibility feature to the accessibility service, receiving a plurality of accessibility commands, during gameplay, from the accessibility service; and executing the plurality of accessibility commands to implement the first accessibility feature.

In an example, sending the first accessibility feature to the accessibility service further comprises sending a unique identifier for a player with the first accessibility feature

In another example, a first accessibility command comprises a gameplay control command, and wherein executing the gameplay control command comprises generating a gameplay action based upon the gameplay control command and user input.

In yet another example, generating the gameplay action further comprises modifying the user input based upon the gameplay control command.

In a further example, generating the gameplay action further comprises supplementing the user input with the gameplay control command.

In another example, executing a plurality of accessibility commands further comprises: comparing a first accessibility command against a game constraint; determining, based upon the comparison of the first accessibility command, a modification to the that the first accessibility command; executing the modified first accessibility command; comparing a second accessibility command to the game constraint; and based upon the comparison of the second accessibility command, executing the second accessibility command without modification.

In yet another example, the computer-implemented method further comprises receiving a suggestion to change an accessibility feature; generating a user interface element based upon the suggestion; displaying the user interface, during gameplay, to change the accessibility feature; receiving a selection of the user interface element, and in response to receiving the selection, sending a second accessibility feature to the accessibility service.

In yet another aspect, the technology relates to a computer storage medium encoding computer-executable instructions that, when executed by at least one processor, cause the at least one processor to perform a method comprising: receiving a selection of an accessibility feature for the game; based upon the accessibility feature, instantiating one or more machine learning model, wherein the one or more machine learning model is operable to generate commands to implement the accessibility feature; receiving current gameplay data; generating, using the one or more machine learning models, an accessibility command, wherein the current gameplay data is provided as an input to the one or more machine learning models; and providing the accessibility command to the game, wherein providing the accessibility command causes implementation of the accessibility feature during gameplay.

In an example, instantiating one or more machine learning models comprises instantiating at least one of: a game machine learning model; a cohort machine learning model; or a user specific machine learning model.

In yet another example, the cohort machine learning model trained to generate accessibility commands for a specific impairment.

In still another example, the user specific machine learning model is a machine learning model trained to generate accessibility commands for a specific user.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (agent structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method for providing accessibility features for a game using an accessibility service, the method comprising:
receiving a selection of an accessibility feature for the game;
based upon the accessibility feature, instantiating one or more machine learning model, wherein the one or more machine learning model is operable to generate commands to implement the accessibility feature;
receiving current gameplay data;
generating, using the one or more machine learning models, an accessibility command, wherein the current gameplay data is provided as an input to the one or more machine learning models; and
providing the accessibility command to the game, wherein providing the accessibility command causes implementation of the accessibility feature during gameplay.

2. The computer-implemented method of claim 1, wherein the gameplay data comprises one or more of:
current user input;
game state information;
information about other player characters; or
non-player character information.

3. The computer-implemented method of claim 1, wherein receiving current gameplay data comprises receiving a current view of the game, wherein the current view of the game is the view depicted to a player during gameplay.

4. The computer-implemented method of claim 1, wherein receiving current gameplay data further comprises, processing the current view of the game, using computer vision, to generate gameplay data.

5. The computer-implemented method of claim 1, wherein instantiating one or more machine learning models comprises instantiating at least one of:
a game machine learning model;
a cohort machine learning model; or
a user specific machine learning model.

6. The computer-implemented method of claim 5, wherein the cohort machine learning model trained to generate accessibility commands for a specific impairment.

7. The computer-implemented method of claim 5, wherein the user specific machine learning model is a machine learning model trained to generate accessibility commands for a specific user.

8. The computer-implemented method of claim 1, further comprising, in response to providing the accessibility command, receiving user input responsive to an adjustment made by the accessibility command.

9. The computer-implemented method of claim 8, further comprising, updating the one or more machine learning models based upon the user input responsive to the adjustment made by the accessibility command.

10. A computer-implemented method for proving an accessibility user interface for a game based upon accessibility features provided by an accessibility service, the method comprising:
generating a user interface depicting a plurality of accessibility features, wherein the plurality of accessibility features comprise accessibility features provided by the accessibility service, and wherein the accessibility service is a service separate from the game;
receiving a selection of a first accessibility feature provided by the accessibility service;
sending the first accessibility feature to the accessibility service; and
in response to sending the accessibility feature to the accessibility service, receiving a plurality of accessibility commands, during gameplay, from the accessibility service; and
executing the plurality of accessibility commands to implement the first accessibility feature.

11. The computer-implemented method of claim 10, wherein sending the first accessibility feature to the accessibility service further comprises sending a unique identifier for a player with the first accessibility feature.

12. The computer-implemented method of claim 10, wherein a first accessibility command comprises a gameplay control command, and wherein executing the gameplay control command comprises generating a gameplay action based upon the gameplay control command and user input.

13. The computer-implemented method of claim 12, wherein generating the gameplay action further comprises modifying the user input based upon the gameplay control command.

14. The computer-implemented method of claim 12, wherein generating the gameplay action further comprises supplementing the user input with the gameplay control command.

15. The computer-implemented method of claim 10, wherein executing a plurality of accessibility commands further comprises:
comparing a first accessibility command against a game constraint;
determining, based upon the comparison of the first accessibility command, a modification to the that the first accessibility command;
executing the modified first accessibility command;
comparing a second accessibility command to the game constraint; and
based upon the comparison of the second accessibility command, executing the second accessibility command without modification.

16. The computer-implemented method of claim 10, further comprising:
receiving a suggestion to change an accessibility feature;
generating a user interface element based upon the suggestion;
displaying the user interface, during gameplay, to change the accessibility feature;
receiving a selection of the user interface element, and
in response to receiving the selection, sending a second accessibility feature to the accessibility service.

17. A computer storage medium encoding computer-executable instructions that, when executed by at least one processor, cause the at least one processor to perform a method comprising:
receiving a selection of an accessibility feature for the game;
based upon the accessibility feature, instantiating one or more machine learning model, wherein the one or more machine learning model is operable to generate commands to implement the accessibility feature;
receiving current gameplay data;
generating, using the one or more machine learning models, an accessibility command, wherein the current gameplay data is provided as an input to the one or more machine learning models; and
providing the accessibility command to the game, wherein providing the accessibility command causes implementation of the accessibility feature during gameplay.

18. The computer storage medium of claim 17, wherein instantiating one or more machine learning models comprises instantiating at least one of:
a game machine learning model;
a cohort machine learning model; or
a user specific machine learning model.

19. The computer storage medium of claim 18, wherein the cohort machine learning model trained to generate accessibility commands for a specific impairment.

20. The computer storage medium of claim 18, wherein the user specific machine learning model is a machine learning model trained to generate accessibility commands for a specific user.
